(19) United States
(12) Patent Application Publication
(10) Pub. No.: US 2025/0037255 A1
(43) Pub. Date: Jan. 30, 2025

(54) METHOD FOR TRAINING DEFECTIVE-SPOT DETECTION MODEL, METHOD FOR DETECTING DEFECTIVE-SPOT, AND METHOD FOR RESTORING DEFECTIVE-SPOT

(71) Applicant: BOE TECHNOLOGY GROUP CO., LTD.

(72) Inventors: Dan ZHU, Beijing (CN); Ran DUAN, Beijing (CN)

(21) Appl. No.: 18/282,589

(22) PCT Filed: Oct. 28, 2022
(86) PCT No.: PCT/CN2022/128222

§ 371 Date: Sep. 18, 2023

(51) Int. Cl. G06T 7/00; G06T 3/40; G06T 3/60; G06T 5/20; G06T 5/50; G06T 7/13; G06V 20/70

(52) U.S. Cl. CPC G06T 7/0002; G06T 3/40; G06T 3/60; G06T 5/20; G06T 5/50; G06T 7/13; G06V 20/70; G06T 2207/20032; G06T 2207/20081; G06T 2207/20221

(57) ABSTRACT

The present disclosure provides a defective-spot detection model training method, a defective-spot detection method and a defective-spot restoration method. The defective-spot detection model training method includes: obtaining a first training data set and a second training data set; generating a transparent layer based on a resolution of the sample detection image; replacing an image in a certain region of the transparent layer based on at least one of the plurality of frames of sample defective-spot images to generate a frame of transparent mask; generating a sample training image with a defective-spot based on the frame of transparent mask and the sample detection image; and processing the sample detection image by using the at least one of the plurality of frames of sample defective-spot images to generate a frame of sample training image.

### FIELD OF THE PRESENT DISCLOSURE

The present disclosure belongs to the technical field of computer vision, and in particular, to a method for training a defective-spot detection model, a method for detecting a defective-spot, and a method for restoring a defective-spot.

### BACKGROUND OF THE PRESENT DISCLOSURE

With the development of computer vision and artificial intelligence, more and more product defect detection adopts a machine vision method to replace the traditional artificial detection, and many defect detection methods based on deep learning have excellent performance. However, in an actual detection environment, the number of non-defective samples is often much larger than that of defective samples, and the imbalance between positive and negative samples may cause insufficient training of a model requiring a large amount of label data, thereby affecting the detection effect.

### SUMMARY OF THE PRESENT DISCLOSURE

In order to solve the problem in the related art, embodiments of the present disclosure provide a method for training a defective-spot detection model, a method for detecting a defective-spot, and a method for restoring a defective-spot.

As a first aspect, the technical solution adopted to solve the disclosed technical problem is a method for training a defective-spot detection model, which includes: obtaining a first training data set and a second training data set; wherein the first training data set includes a plurality of frames of sample detection images, and the second training data set includes a plurality of frames of sample defective-spot images; for each frame of sample detection image, processing the frame of sample detection image by using at least one of the plurality of frames of sample defective-spot images, to generate a frame of sample training image; and training the defective-spot detection model by using the plurality of frames of sample training images until a loss value is converged, so as to obtain a trained defective-spot detection model; wherein for each frame of sample detection image, processing the frame of sample detection image by using at least one of the plurality of frames of sample defective-spot images to generate a frame of sample training image, includes: generating a transparent layer based on a resolution of the sample detection image; replacing an image in a certain region of the transparent layer based on at least one of the plurality of frames of sample defective-spot images, to generate a frame of transparent mask; and generating the sample training image with a defective-spot based on the frame of transparent mask and the sample detection image.

In some embodiments, determining the plurality of frames of sample defective-spot images includes: generating defective-spot image data in a target region of a preset image by using a grid dyeing method, to obtain a first defective-spot image sample; performing an image expansion process on the first defective-spot image sample to obtain a second defective-spot image sample; performing a median filtering process on the second defective-spot image sample to obtain a third defective-spot image sample, and determining edge position information of the third defective-spot image sample; and extracting the defective-spot image data based on the edge position information of the third defective-spot image sample to obtain the sample defective-spot image.

In some embodiments, generating the defective-spot image data in the target region of the preset image by using the grid dyeing method to obtain the first defective-spot image sample, includes: determining any two positions of each of multiple rows of pixels in the target region to generate a line segment with a preset width; and sequentially processing each row of the multiple rows of pixels to obtain multiple line segments, so as to obtain the first defective-spot image sample.

In some embodiments, performing the median filtering process on the second defective-spot image sample to obtain the third defective-spot image sample, includes: obtaining a median filtering kernel; and for each pixel in the second defective-spot image sample, determining a target gray-scale value of a middle pixel corresponding to the median filter kernel, based on the gray-scale values of the pixels corresponding to the median filter kernel, so as to obtain the third defective-spot image sample.

In some embodiments, determining the edge position information of the third defective-spot image sample, includes: throughout all rows of pixels of the third defective-spot image sample, sequentially determining a target pixel with a preset gray-scale value in each row of pixels; and determining the edge position information of the third defective-spot image sample based on the position information of the target pixel.

In some embodiments, extracting the defective-spot image data based on the edge position information of the third defective-spot image sample to obtain the sample defective-spot image, includes: extracting the defective-spot image data based on the edge position information of the third defective-spot image sample, so as to obtain a fourth defective-spot image sample; and performing data processing on the fourth defective-spot image sample to obtain of a plurality of sample defective-spot images in different types; wherein the plurality of sample defective-spot images in different types includes at least one of followings: the fourth defective-spot image sample; an image obtained by rotating the fourth defective-spot image sample by a preset angle; an image horizontal symmetrical to the fourth defective-spot image sample; an image vertically symmetrical to the fourth defective-spot image sample; the fourth defective-spot image samples with different gray colors; and the scaled fourth defective-spot image sample by a preset size proportion.

In some embodiments, replacing the image in the certain region of the transparent layer based on the at least one of the plurality of frames of sample defective-spot images to generate the frame of transparent mask, includes: determining the certain region of the transparent layer based on a resolution of the at least one of the plurality of frames of sample defective-spot images; and replacing the image in the certain region of the transparent layer by using the at least one of the plurality of frames of sample defective-spot images to generate the frame of transparent mask.

In some embodiments, wherein after generating the transparent layer based on the resolution of the sample detection image, the method further includes: generating a piece of label data based on the at least one of the plurality of frames of sample defective-spot images and the transparent layer; and training the defective-spot detection model by using the plurality of frames of sample training images until the loss value is converged, so as to obtain the trained defective-spot detection model includes: training the defective-spot detection model by using the plurality of frames of sample training images and the plurality of pieces of label data until the loss value is converged, so as to obtain the trained defective-spot detection model.

As a second aspect, an embodiment of the present disclosure provides a device for training a defective-spot detection model, which includes: a first obtaining module, a training image generation module and a first training module. The first obtaining module is configured to obtain a first training data set and a second training data set; wherein the first training data set includes a plurality of frames of sample detection images, and the second training data set includes a plurality of frames of sample defective-spot images; the training image generation module is configured to: for each of the plurality of frames of sample detection images, process the sample detection image by using at least one of the plurality of frames of sample defective-spot images, to generate a frame of sample training image; and the first training module is configured to train the defective-spot detection model by using the plurality of frames of sample training images until a loss value is converged, so as to obtain a trained defective-spot detection model. The training image generation module includes a layer generation unit, a mask generation unit and a training image generation unit. The layer generation unit is configured to generate a transparent layer based on a resolution of the sample detection image; the mask generation unit is configured to replace an image of a certain region in the transparent layer based on at least one of the plurality of frames of sample defective-spot images to generate a frame of transparent mask; and the training image generation unit is configured to generate the sample training image with a defective-spot based on the frame of transparent mask and the sample detection image.

As a third aspect, an embodiment of the present disclosure provides a defective-spot detection method, applied to the defective-spot detection model trained by the method of any one of the embodiments described above. The defective-spot detection method includes: obtaining a video stream; and performing defective-spot detection on each video frame in the video stream by using the defective-spot detection model to obtain a target detection result of each video frame.

As a fourth aspect, an embodiment of the present disclosure provides a method for restoring a defective-spot, including: obtaining a target detection result with a defective-spot output by a defective-spot detection model, a first video frame corresponding to the target detection result with the defective-spot, and at least one second video frame adjacent to the first video frame in a video stream; determining a defective-spot mask of the first video frame based on the target detection result; filtering the first video frame and the at least one second video frame to obtain a first filtered image; obtaining an initial restored image based on the first filtered image, the defective-spot mask and the first video frame; and processing, by using a defective-spot restoration network model, the first video frame, the at least one second video frame, the defective-spot mask and the initial restored image, so as to obtain a target image with the defective-spot restored.

In some embodiments, the second video frame includes N frames, wherein N/2 frames of the second video frame are previous video frames adjacent to the first video frame, and N/2 frames of the second video frame are subsequent video frames adjacent to the first video frame; n is an even number greater than 0. Filtering the first video frame and the at least one second video frame to obtain the first filtered image, includes: for a same pixel, sorting the gray-scale values of the same pixel in the first video frame and each of the at least one second video frame from small to large, and taking a middle gray-scale value of the sorted gray-scale values as a target gray-scale value of the pixel; and processing each pixel throughout all pixel in the first video frame and each second video frame, to determine the first filtered image based on the target pixel value of each pixel.

In some embodiments, obtaining the initial restored image based on the first filtered image, the defective-spot mask and the first video frame includes: replacing an image in a region in the first video frame indicated by position information of a defective-spot image with an image in a region in the first filtered image indicated by the position information of the defective-spot image, based on the position information of the defective-spot image in the defective-spot mask, to obtain the initial restored image.

In some embodiments, processing, by using the defective-spot restoration network model, the first video frame, the at least one second video frame, the defective-spot mask and the initial restored image, so as to obtain the target image with the defective-spot restored, includes: processing data of each pixel in each of the first video frame, the at least one second video frame, the defective-spot mask and the initial restored image to obtain input data; inputting the input data into the defective-spot restoration network model, and respectively performing downsampling process of different sizes on the input data to obtain first input sub-data corresponding to a subnetwork branch in the defective-spot restoration network model; wherein the input data of a first-level subnetwork branch comprises two pieces of same first input sub-data; each of other subnetwork branches except the first-level subnetwork branch performs an upsampling process on output data of the previous-level subnetwork branch and receives the upsampling result as second input sub-data of the subnetwork branch, to obtain the target image output by a last-level subnetwork branch; a resolution of a feature map corresponding to the first input sub-data of an upper-level subnetwork branch is smaller than a resolution of a feature map corresponding to the first input sub-data of a lower-level subnetwork branch.

In some embodiments, training the defective-spot restoration network model includes: for output result of each level of subnetwork branch, determining a first loss value of a defective-spot image and a second loss value of a non-defective-spot image in the output result based on the defective-spot mask, the output result and a real result corresponding to the output result; replacing an image in a region in the output result indicated by position information of the defective-spot image with an image in a region in the real result indicated by the position information of the defective-spot image, based on the position information of the defective-spot image in the defective-spot mask, so as to obtain a first intermediate result; inputting the first intermediate result, the output result and the real result corresponding to the output result into a convolutional neural network to obtain a first intermediate feature, a second intermediate feature and a third intermediate feature, and determining a third loss value based on the first intermediate feature, the second intermediate feature and the third intermediate feature; performing a specific matrix transformation on the first intermediate feature, the second intermediate feature and the third intermediate feature to obtain a first transformation result, a second transformation result and a third transformation result, respectively; determining a fourth loss value based on the first transformation result, the second transformation result, and the third transformation result; weighting the first loss value, the second loss value, the third loss value and the fourth loss value to obtain a weighted loss value corresponding to each level of subnetwork branch; weighting the weighted loss value corresponding to each level of subnetwork branch to obtain a target weighted loss value; and continuously training the defective-spot restoration network model by performing weighted back propagation on the target weighted loss value, until the target weighted loss value is converged, to obtain the trained defective-spot restoration network model.

As a fifth aspect, an embodiment of the present disclosure provides a defective-spot restoration device, including: a second obtaining module, a mask determination module, a filtering module, a first restoration module and a second restoration module. The second obtaining module is configured to obtain a target detection result with a defective-spot output by a defective-spot detection model, a first video frame corresponding to the target detection result with the defective-spot, and at least one second video frame adjacent to the first video frame in a video stream; the mask determination module is configured to determine a defective-spot mask of the first video frame based on the target detection result; the filtering module is configured to perform a filtering process on the first video frame and the at least one second video frame to obtain a first filtered image; the first restoration module is configured to obtain an initial restored image based on the first filtered image, the defective-spot mask and the first video frame; and the second restoration module is configured to process, through a defective-spot restoration network model, the first video frame, the at least one second video frame, the defective-spot mask and the initial restored image, so as to obtain a target image with the defective-spot restored.

As a sixth aspect, an embodiment of the present disclosure provides a computer device, including: a processor, a memory, and a bus. The memory stores machine-readable instructions executable by the processor, the processor communicates with the memory over the bus when the computer device runs, the machine-readable instructions when executed by the processor perform the method for training a defective-spot detection model described above; or, the machine readable instructions when executed by the processor perform the defective-spot detection method described above; or, the machine readable instructions when executed by the processor perform the method for restoring a defective-spot described above.

As a seventh aspect, an embodiment of the present disclosure provides a computer non-transitory readable storage medium having a computer program stored thereon, when executed by a processor, performs the method for training a defective-spot detection model; or, the computer program when executed by a processor performs the defective-spot detection method described above; or the computer program when executed by a processor performs method for restoring a defective-spot described above.

### BRIEF DESCRIPTION OF THE DRAWINGS

FIG. 1 is a flowchart of method for training a defective-spot detection model in an embodiment of the present disclosure;

FIG. 2 is a schematic diagram showing a transparent mask in an embodiment of the present disclosure;

FIG. 3a is a schematic diagram showing a first defective-spot image sample in an embodiment of the present disclosure;

FIG. 3b is a schematic diagram showing a second defective-spot image sample in an embodiment of the present disclosure;

FIG. 3c is a schematic diagram showing a third defective-spot image sample in an embodiment of the present disclosure;

FIGS. 4a to 4h are schematic diagrams showing various sample defective-spot images in an embodiment of the present disclosure;

FIG. 5 is a schematic flow chart of automatically simulating a defective-spot in an embodiment of the present disclosure;

FIG. 6 is a schematic diagram showing a training apparatus for training a defective-spot detection model in an embodiment of the present disclosure;

FIG. 7 is a flowchart showing a method for restoring a defective-spot in an embodiment of the present disclosure;

FIG. 8 is a schematic diagram showing a first video frame vs a defective-spot mask in an embodiment of the present disclosure;

FIG. 9a is a schematic flowchart of determining an initial restored image in an embodiment of the present disclosure;

FIG. 9b is a schematic flowchart of determining a target image in an embodiment of the present disclosure;

FIG. 10 is a schematic flowchart of processing data with a defective-spot restoration network model in an embodiment of the present disclosure;

FIG. 11 is a schematic diagram showing specific structures of models of a sub-network 1, a sub-network 2 and a sub-network 3 in an embodiment of the present disclosure;

FIG. 12 is a schematic diagram showing a model structure of an exemplary attention module in an embodiment of the present disclosure;

FIG. 13 is a schematic flow chart of updating parameters of a loss function calculation model in an embodiment of the present disclosure;

FIG. 14 is a schematic diagram showing a defective-spot restoration device in an embodiment of the present disclosure; and

FIG. 15 is a schematic diagram showing a structure of a computer device in an embodiment of the present disclosure.

### DETAILED DESCRIPTION OF THE EXEMPLARY EMBODIMENTS

In order to make the objects, technical solutions and advantages of the embodiments of the present disclosure more apparent, the technical solutions in the embodiments of the present disclosure will be described clearly and completely with reference to the drawings in the embodiments of the present disclosure, and it is obvious that the described embodiments are only a part of the embodiments of the present disclosure, not all of the embodiments. The components of the embodiments of the present disclosure, as generally described and shown in the drawings herein, could be arranged and designed in a wide variety of different configurations. Thus, the following detailed description of the embodiments of the present disclosure, provided in the accompanying drawings, is not intended to limit the scope of the present disclosure, as claimed, but is merely representative of selected embodiments of the present disclosure. All other embodiments, which can be derived by a person skilled in the art from the embodiments of the present disclosure without making any creative effort, shall fall within the protection scope of the present disclosure.

Unless defined otherwise, technical or scientific terms used herein shall have the ordinary meaning as understood by one of ordinary skill in the art to which the present disclosure belongs. The use of “first,” “second,” and the like in the present disclosure is not intended to indicate any order, quantity, or importance, but rather is used to distinguish one element from another. Also, the use of the terms “a”, “an”, or “the” and similar referents do not denote a limitation of quantity, but rather denote the presence of at least one. The word “include” or “comprise”, and the like, means that the element or item preceding the word comprises the element or item listed after the word and its equivalent, but does not exclude other elements or items. The terms “connect” or “couple” and the like are not restricted to physical or mechanical connections, but may include electrical connections, whether direct or indirect. “Upper”, “lower”, “left”, “right”, and the like are used only to indicate relative positional relationships, and when the absolute position of the object being described is changed, the relative positional relationships may also be changed accordingly.

Reference to “a plurality of or a number of” in the present disclosure means two or more items. “And/or” describes the association relationship of the associated object, indicating that there may be three relationships, for example, A and/or B, which may indicate: A exists alone, A and B exist simultaneously, and B exists alone. The character “/” generally indicates that the one before “/” and one after “/” are in an “or” relationship.

In the related art, for old films and film movies, defective-spots are automatically detected by using machine vision. A defective-spot detection model needs to be trained in advance, and the automatic detection may be realized by using the trained defective-spot detection model. In general, the number of material video frames in the old films and the film movies is small, and thus the number of material video frames with a defective-spot (i.e., a set of bad pixels) is small as well. Since the number of the material video frames in the old films and the film movies is limited, the model requiring a large amount of label data is trained insufficiently by using a small amount of sample data sets, thereby affecting the detection effect. In addition, a manual labeling method is usually adopted at present to label defective-spots of the samples, however the efficiency of the manual labeling method is low and the cost of the manual labeling method is high.

Based on this, the disclosed embodiments provide a defective-spot detection model training method that substantially obviates one or more of the problems due to limitations and disadvantages of the related art. Specifically, a first training data set and a second training data set are obtained; the first training data set includes a plurality of frames of sample detection images; the second training data set includes a plurality of frames of sample defective-spot images; for each frame of sample detection image, processing the sample detection image by using at least one frame of the plurality of frames of sample defective-spot images to generate a frame of sample training image; training the defective-spot detection model by using a multi-frame sample training image until the loss value is converged to obtain a trained defective-spot detection model; for each frame of sample detection image, processing the sample detection image by using at least one frame of the plurality of frames of sample defective-spot images to generate a frame of sample training image, and the method includes the following steps: generating a transparent layer based on the resolution of the sample detection image; replacing and displaying the image of the certain region in the transparent layer based on at least one frame of the plurality of frames of sample defective-spot images to generate a frame of transparent mask; and generating a sample training image with defective-spots based on the frame of transparent mask and the sample detection image.

According to the embodiment of the present disclosure, a large number of sample training images containing defective-spots are generated by using the acquired second training data set containing a large number of sample defective-spot images and the first training data set (data set of sample detection images without defective-spots), and the number of negative sample training samples of the model is increased by using the large number of sample training images containing defective-spots, so that the accuracy of the defective-spot detection model can be improved when training is completed.

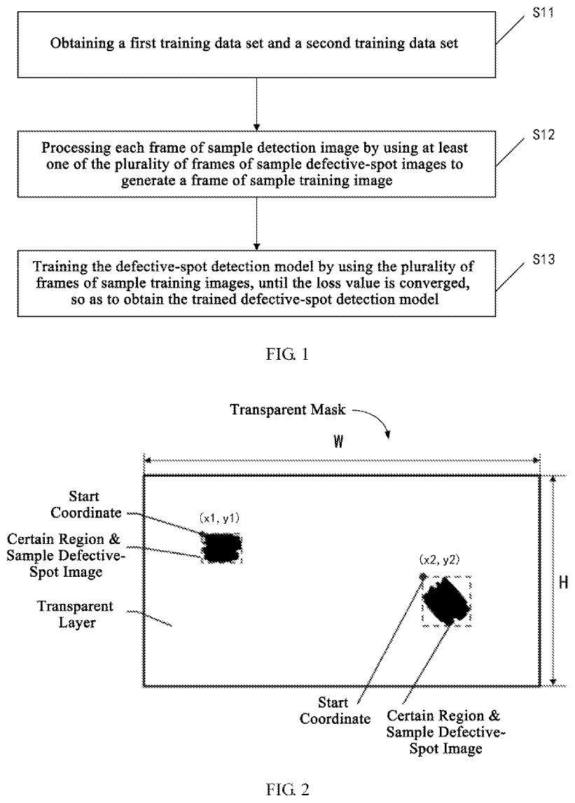

It should be noted that the image in the embodiment refers to display data of an image and includes a gray-scale value of each of the pixels. The method for training the defective-spot detection model in an embodiment of the present disclosure will be described in detail below. FIG. 1 is a flowchart of the method for training the defective-spot detection model in an embodiment of the present disclosure. As shown in FIG. 1, the method specifically includes steps S11 to S13.

At step S11, obtaining a first training data set and a second training data set.

The first training data set includes a plurality of frames of sample detection images; and the second training data set includes a plurality of frames of sample defective-spot images.

In the step, the first training data set may be a preset video frame, such as a video frame in a simulated old film or a video frame in a simulated film movie; alternatively, the first training data set may be a multi-frame material image obtained from a database. The first training data set includes a plurality of frames of sample detection images, such as, images in old films or images in film movies, etc.

It should be noted that, by default, no defective-spot exists in the sample detection image in the first training data set. And subsequently, the sample detection image is labeled by using the sample defective-spot image so as to generate a sample training image.

The resolution of each frame of sample detection image in the first training data set is the same as each other.

The second training data set may be a set of frames of images each containing a defective-spot generated in advance, where the sample defective-spot image is an image obtained by simulating a defective-spot instead of an image having a real defective-spot. And/or, the second training data set may also be a set of frames of images each containing a defective-spot obtained from a database, in this case the sample defective-spot image is an image having a real defective-spot, such as an image having a defective-spot extracted from an old photograph, or an image having a defective-spot extracted from a film movie.

At step S12, processing each frame of sample detection image by using at least one frame of the plurality of frames of sample defective-spot images to generate a frame of sample training image.

The step is a description of automatic labeling a defective-spot in a frame of sample detection image to generate a frame of sample training image. Step S12 may be performed on each of a plurality of frames of sample detection images, so that the sample training images may be obtained by labeling each frame of sample detection image, that is, to form a sample training set. Subsequently, the sample training set may be used to train the defective-spot detection model.

Automatic labeling the defective-spot in a frame of sample detection image specifically includes processing the sample detection image by using a frame of sample defective-spot image to generate a frame of sample training image, wherein the sample training image includes one defective-spot; alternatively, includes processing the sample detection image by using multiple frames of sample defective-spot images to generate a frame of sample training image, wherein the sample training image includes multiple defective-spots.

Automatic labeling the defective-spot in each frame of sample detection image to generate a frame of sample training image may include steps S12-1 to S12-3.

At step S12-1, generating a transparent layer based on a resolution of the sample detection image.

In the step, a frame of transparent layer having the same resolution as the resolution W×H of the sample detection image is generated according to the resolution W×H of the sample detection image. The transparent layer may be an RGBA image, where A represents an alpha channel. The transparent layer is completely transparent by setting a value of the alpha channel in the transparent layer.

At step S12-2, replacing an image in a certain region in the transparent layer based on at least one of the plurality of frames of sample defective-spot images, to generate a frame of transparent mask.

In the step, the certain region in the transparent layer may be a predetermined fixed region, or an active region determined in real time. A range of the fixed region may be defined according to actual application scenarios and experience. The range of the active region may be determined based on a randomly selected position set point and the resolution of the current frame of sample defective-spot image.

FIG. 2 is a schematic diagram showing a transparent mask in an embodiment of the present disclosure. FIG. 2 shows an embodiment in which the certain region in the transparent layer is an active region as an example, the certain region in the transparent layer is determined based on a resolution of at least one of the plurality of frames of sample defective-spot images. The image in the certain region of the transparent layer is replaced with at least one of the plurality of frames of sample defective-spot images to generate a frame of transparent mask. Specifically, determining the resolution of the frame of sample defective-spot image to be w×h, selecting start coordinates (x1, y1), where the range of the start coordinates (x1, y1) in the transparent layer is 0≤x1≤(W−w) and 0≤y1≤(H−h), determining a certain region in the transparent layer according to the resolution w×h of the sample defective-spot image based on the start coordinates (x1, y1), wherein the resolution of the image in the certain region is the same as the resolution w×h of the sample defective-spot image, and replacing the image in the certain region of the transparent layer with the sample defective-spot image. When a plurality of frames of sample defective-spot images exist, the start coordinates (x2, y2) for other frames of the plurality of frames of sample defective-spot images are randomly generated, until each of the plurality of frames of sample defective-spot images is replaced, so as to generate a transparent mask. The transparent mask is an image containing defective-spot data, and the remaining image of the transparent mask except the defective-spot image is a transparent image.

An embodiment in which the certain region of the transparent layer is a fixed region will be illustrated as an example. The transparent layer has a middle region and an edge region, where the middle region ranges in x1≤(W−w), 0≤y1(H−h), where w×h represents the maximum resolution of the sample defective-spot images in the second training data set. The edge region is a region surrounding the middle region, and the certain region is the middle region. For each frame of sample defective-spot image, fixed coordinates (x1, y1) are randomly generated in the certain region; and the image in the transparent layer is replaced with the sample defective-spot image based on the fixed coordinates (x1, y1) according to the resolution w×h of the sample defective-spot image.

At step S12-3, generating a sample training image with a defective-spot based on the frame of transparent mask and the sample detection image.

After the transparent mask is generated and data labeling is completed, the generated frame of transparent mask and a frame of sample detection image are synthesized together, that is to say, a defective-spot in the transparent mask at a position where defective-spot data exists is reserved, and the content of the sample detection image at positions where no defective-spot data exists is reserved.

For example, the sample training image INXₒᵤₜ with the defective-spot may be determined according to the following formula 1:

$$INXout = \frac{MASK 1}{255} \times MASK 1 + \vert \frac{MASK 1}{255} - 1 \vert \times INX \qquad Formula 1$$

Where INXₒᵤₜ represents the sample training image with a defective-spot; MASK1 represents a transparent mask, with a grayscale value of 255 at pixels with defective-spot data and a grayscale value of 0 at pixels without defective-spot data; INX represents the sample detection image.

At step S13, training the defective-spot detection model by using the plurality of frames of sample training images, until the loss value is converged, so as to obtain the trained defective-spot detection model.

In the step, the defective-spot detection model may be a target detection model based on the YOLOv5 neural network. YOLO (You Only Look Once) is a network for target detection. The target detection includes determining where certain objects are present in the image and classifying the certain objects. YOLOv5 is an improved algorithm on the basis of YOLO. YOLOv5 is a single-stage target detection algorithm, and new improvement ideas are added to the YOLO (specifically YOLOv4) so that the speed and the precision of the YOLOv5 can be greatly improved. Alternatively, the defective-spot detection model may be another deep learning neural network model that can implement functions of data classification and data detection.

Specifically, the plurality of frames of sample training images are input into the defective-spot detection model, and a prediction result is output from the defective-spot detection model. A weighted loss value is calculated based on a preset result and a pre-labeled real result; and the defective-spot detection model is continuously trained by performing weighted back propagation on the weighted loss value until the weighted loss value is converged, so as to obtain the trained defective-spot detection model.

Here, with the pre-labeled real result (i.e., label data), the embodiment of the present disclosure can implement automatic defective-spot labeling. Specifically, at step S12-2, while generating the transparent mask, a piece of label data is generated based on at least one of the plurality of frames of sample defective-spot images and the transparent layer.

Taking an embodiment in which the certain region of the transparent layer is an active region as an example. The resolution of a frame of sample defective-spot image is determined to be w×h, start coordinates (x1, y1) are selected with the range of the start coordinates (x1, y1) in the transparent layer being 0≤x1≤(W−w), 0≤y1≤(H−h). Label data is generated according to the resolution w×h of the sample defective-spot image based on the start coordinates (x1, y1). The label data include a percentage of an abscissa of the central position of the sample defective-spot image to an abscissa of the transparent image, namely (x1+w/2)/W, a percentage of an ordinate of the central position of the sample defective-spot image to an ordinate of the transparent image, namely (y1+h/2)/H, a percentage of a length of the sample defective-spot image to a length of the transparent image, namely w/W, a percentage of a height of the sample defective-spot image to a height of the transparent image, namely h/H, and a tag id. The tag id is for the only one category (i.e., defective spot), and the tag id of all the defective-spot data can be set to zero (0). If other categories other than defective-spots exist, different tag ids may be set for other categories. The label data is [id, (x1+w/2)/W, (y1+h/2)/H, w/W, h/H]. Each frame of sample defective-spot image corresponds to a corresponding piece of label data, and a plurality of frames of sample defective-spot images correspond to a plurality of pieces of label data, respectively.

The method for automatically labeling the defective-spot data according to the sample defective-spot image and the transparent layer in the embodiment of the present disclosure can improve the labeling efficiency of the defective-spot, improve the training efficiency of the model, and reduce the cost of the defective-spot labeling, as compared with a manual labeling method in the prior art. In addition, in the embodiment of the present disclosure, since the defective-spot is regarded as a standard object, the defective-spot detection may be converted into classification detection, and the selectivity of a defective-spot detection model can be effectively improved, for example, models such as a YOLOv5 neural network, a deep learning neural network for realizing a data classification function and a data detection function can be selected.

When step S13 is executed, the defective-spot detection model is trained by using the plurality of frames of sample training images and the plurality of pieces of label data, until the loss value is converged, so as to obtain the trained defective-spot detection model.

Each frame of sample training image corresponds to at least one piece of label data. Each frame of sample training image corresponds to a prediction result. The loss calculation is performed by using at least one piece of label data (i.e., the real result) corresponding to the frame of sample training image to determine a weighted loss value.

The prediction result includes a confidence level of the detection and the label information of the detected defective-spot, and a structure of the label information is the same as that of the label data. The confidence level represents a probability of the presence of the defective-spot in a position indicated by the label information output from the defective-spot detection model. A confidence threshold may be selected according to actual conditions. For example, the confidence threshold is selected as T. If the output confidence level is greater than or equal to T, it means that a defective-spot exists at a position indicated by the label information in the prediction result; and if the output confidence level is smaller than T, it means that no defective-spot exists at the position indicated by the label information in the prediction result.

In the present disclosure, the loss value of a prediction box may be determined by constructing the IOU, GIOU, DIOU, or CIOU loss function. For example, the IOU loss function represents a difference in the intersection ratio between a prediction box A and a ground truth box B and reflects the detection effect of the prediction box. The prediction box A is determined based on the label information in the prediction results, and the ground truth box B is determined based on the label data of the real result. The loss value L of the prediction box is determined to as L_{IOU}=1−IOU (A, B). Similarly, the GIOU, DIOU, or CIOU loss function may also be used to determine the loss value of the prediction box, which will not be illustrated one by one here. The loss value L between the confidence level and the confidence threshold is determined as L_{obj}=−[tlogt′+(1−t)] log (1−t′), where t represents the confidence level, and t′ represents the confidence threshold. The weighted loss value L=aL_{IOU}+bL_{obj} may be obtained by performing weighted processing on the loss value L_{IOU} and the loss value L_{obj}, where the weighting factors a and b may be set based on experience. The defective-spot detection model is continuously trained by performing weighted back propagation on the weighted loss value until the weighted loss value is converged.

Under some application environments, the amount of material samples is limited, for example, the samples of defective-spot images in old films and film movies are limited, therefore the defective-spot detection model which needs a large number of training samples is insufficiently trained, the training effect is influenced, and the model detection precision is reduced. As such, the sample defective-spot image in the second training data set in the present disclosure is an image that automatically simulates the defective-spot, so as to solve the problem that there are fewer defective-spot materials in a real scene. Determining the plurality of frames of sample defective-spot images includes steps S21 to S24.

At step S21, generating defective-spot image data in the target region of the preset image by using a grid dyeing method to obtain a first defective-spot image sample.

The preset image may be a gray-scale image, for example, a white image with a gray-scale value of 255. The target region may be, for example, a fixed region with a size of N×N.

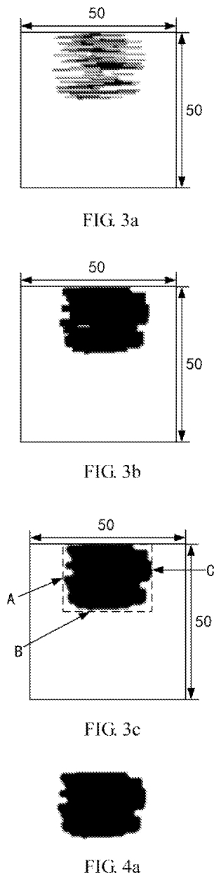

FIG. 3a is a schematic diagram showing a first defective-spot image sample in an embodiment of the present disclosure. As shown in FIG. 3a, in some embodiments, for each of multiple rows of pixels in the target region, any two positions in each row are determined and a line segment with a preset width is generated; and the processing is repeated in turn throughout the multiple rows of pixels in the target region, to obtain multiple line segments so as to obtain the first defective-spot image sample.

In an embodiment, each of the multiple rows of pixels is sequentially processed starting from the first row of pixels. For each row of pixels, two numbers are randomly generated as the start coordinate and the end coordinate of the line segment, for example, the two numbers are y1 and y2 respectively, and thus the start coordinates are (1, y1) and the end coordinates are (1, y2). The width of the generated line segment is obtained, for example, the width of the line segment ranges from 1 to 5 pixels. Taking the width of the line segment is 1 pixel as an example, the gray-scale values of the pixels from (1, y1) to (1, y2) are adjusted. For example, a pixel with a gray-scale value of 255 (i.e., white) is adjusted to gray-scale value of 0 (i.e., black), so as to obtain a black line segment with the width of 1 pixel. Alternatively, the gray-scale values of the pixels are adjusted such that the pixels have different gray-scales to obtain line segments with different gray-scales. Taking the width of the line segment is 3 pixels as an example, the gray-scale values of the pixels from (1, y1) to (1, y2), the gray-scale values of the pixels from (2, y1) to (2, y2), and the gray-scale values of the pixels from (3, y1) to (3, y2) are adjusted, so that a black line segment with the width of 3 pixels is obtained.

Similarly, the line segment is generated for each of multiple rows of pixels in the target region. When the line segment is generated for each of multiple rows of pixels, an image in a region in which the multiple line segments are located is the obtained first defective-spot image sample.

Herein, taking the target region with a size of 50×50 as an example, a line segment is generated from the first row of pixel, and the process of generating the line segment for n times in total, so that n line segments are generated, with the width of the line segment being 1 to 5 pixels, n is more than 10 to prevent the generated defective-spot image sample from being too flat, and n is less than 45 to prevent the generated defective-spot image sample from exceeding the range of the target region when a line segment with the width of 5 pixels is generated subsequently. Specifically, the value of n may be adjusted according to an actual application scenario, which is not limited in the present disclosure.

Step S21 may simulate the start defective-spot (i.e., the line segments) by using the grid dyeing method for subsequent generating the sample defective-spot image.

At step S22, performing an image expansion process on the first defective-spot image sample to obtain a second defective-spot image sample.

The step may expand/dilate the locations of the line segments (i.e., the defective-spot) in the first defective-spot image sample by using an image dilation algorithm.

FIG. 3b is a schematic diagram showing a second defective-spot image sample in an embodiment of the present disclosure. As shown in FIG. 3b, the first defective-spot image sample may be a binary image, where a foreground defective-spot of the binary image is 1 and a white background of the binary image is 0. The process of the expansion includes: throughout all pixels of the binary image, aligning a center point of a structural element with the currently processed target pixel, obtaining the maximum gray value of all pixels in a region covered by the current structural element in the binary image, and replacing the current gray value of the target pixel with the maximum gray value. Since the maximum value of the binary image is 1, the current gray value of the target pixel is replaced with 1, so that the target pixel becomes the foreground defective-spot. Therefore, it can also be seen that if the white background is covered by the current structural element, since the gray value of the white background is 0, the original image is not changed. Only when the structural element is located on the edge of the foreground defective-spot, two different data, (i.e., 0 and 1) may appear in the region covered by the structural element, in this case the current gray-scale value of the target pixel is replaced by 1 such that the target pixel becomes the foreground defective-spot, above process is referred as the image expansion, that is, the non-defective-spot adjacent to the edge of the defective-spot is expanded to become the defective-spot, so that a second defective-spot image sample is obtained. Herein, the width of the first defective-spot image sample is expanded by 5 pixels.

At step S22, the image expansion process is performed on the simulated initial defective-spot (i.e., the line segments) through the image dilation algorithm to expand the edge of the defective-spot image, so that the defective-spot image can be further optimized, and the simulated defective-spot can be closer to the defective-spot in the real scene.

At step S23, performing a median filtering process on the second defective-spot image sample to obtain a third defective-spot image sample, and determining edge position information of the third defective-spot image sample.

FIG. 3c is a schematic diagram showing a third defective-spot image sample in an embodiment of the present disclosure. As shown in FIG. 3c, obtaining the third defective-spot image sample specifically includes: obtaining a median filter kernel; for each pixel in the second defective-spot image sample, determining gray-scale values of the pixels corresponding to the median filter kernel; determining the gray-scale value of a middle pixel corresponding to the median filter kernel so as to obtain the third defective-spot image sample.

In an embodiment, a 5×5 median filter kernel may be selected to divide the second defective-spot image sample into a middle region and an edge region. The edge region of the second defective-spot image sample includes a region where the first three rows of pixels are located, a region where the first three columns of pixels are located, a region where the last three rows of pixels are located, and a region where the last three columns of pixels are located, and the remaining region of the second defective-spot image sample is the middle region.

For the pixels in the middle region of the second defective-spot image sample, aligning the center point of the median filter kernel to the target pixel which is currently processed; sorting, from small to large, the gray-scale values of all pixels in a region covered by the median filtering kernel in the second defective-spot image sample; and taking the middle value as the new gray-scale value of the target pixel. Follow above steps to sequentially determine a new gray-scale value of each target pixel, throughout all the pixels in the middle region. For the pixels in the edge region of the second defective-spot image sample, aligning the center point of the median filter kernel with the target pixel which is currently processed, in this case only a portion of the region covered by the median filter kernel belongs to the edge region of the second defective-spot image sample, the remaining portion of the covered region exceeds the second defective-spot image sample, by default the region which exceeds the second defective-spot image sample has a gray-scale value of 255; sorting, from small to large, the gray-scale values of all pixels in a region covered by the median filtering kernel; and taking the middle value as the new gray-scale value of the target pixel. Follow above steps to sequentially determine a new gray-scale value of each target pixel, throughout all the pixels in the edge region; determining a new gray-scale value of each pixel in the updated second defective-spot image sample, and taking the updated second defective-spot image sample as a third defective-spot image sample.

Determining edge position information of the third defective-spot image sample specifically includes: throughout all rows of pixels of the third defective-spot image sample, sequentially determining the target pixel with a preset gray-scale value in each row of pixels; and determining the edge position information of the third defective-spot image sample based on the position information of the target pixel.

As shown in FIG. 3c, throughout all rows of pixels of the third defective-spot image sample, sequentially determining the target pixels with a grayscale value of 0 in each row of pixels; based on the position information of each row of target pixels, determining a minimum ordinate value, a maximum ordinate value, a minimum abscissa value, and a maximum abscissa value; According to the minimum ordinate value, the maximum ordinate value, the minimum abscissa value, and the maximum abscissa value, determining the target pixel A with the minimum ordinate value, the target pixel C with the maximum ordinate value, the minimum abscissa value is 0 by default, and target pixel B with the maximum abscissa value, thereby determining the coordinates of the target pixel A are (wₐ, hₐ), the coordinates of the target pixel B are (w_{b}, h_{b}), and the coordinates of the target pixel C are (w_{c}, h_{c}); determining boundaries defined by the edge position information (i.e., (0, m), (wₐ, hₐ), (w_{c}, h_{c}), and (w_{b}, h_{b})) of the third defective-spot image sample, as the boundaries of the third defective-spot image sample, based on the coordinates (wₐ, hₐ) of the target pixel A, the coordinates (w_{b}, h_{b}) of the target pixel B, and the coordinates (w_{c}, h_{c}) of the target pixel C, where the value of m is in a range of hₐ to h_{c}. The region of the third defective-spot image sample ranges from (wₐ, 0) to (w_{c}, h_{b}), which is shown as a dashed box in FIG. 3.

At step S23, the defective-spot simulated in step S22 is further optimized by using the median filtering algorithm. The edge of the defective-spot is smoother through the median filtering algorithm, so that the simulated defective-spot is closer to the defective-spot in the real scene.

At step S24, based on the edge position information of the third defective-spot image sample, extracting defective-spot image data to obtain a sample defective-spot image.

According to the edge position information of the third defective-spot image sample, the image (including the defective-spot) in the edge frame indicated by the edge position information is extracted, and the image in the edge frame is augmented by for example changing the size of the original image, changing the position of the original image, and changing the color of the original image, so as to obtain the sample defective-spot image which is a series of augmented images of the image in the dotted line frame in FIG. 3c.

In some embodiments, based on the edge position information of the third defective-spot image sample, extracting the defective-spot image data to obtain a fourth defective-spot image sample; here the fourth defective-spot image sample is the image in the dashed box in FIG. 3c; performing data processing on the fourth defective-spot image sample to obtain a plurality of sample defective-spot images of different types, wherein the data processing may be augmentation processing, for example, rotating the fourth defective-spot image sample by a preset angle (e.g., 65°) to obtain a sample defective-spot image; or, obtaining a sample defective-spot image which is horizontally symmetrical to the fourth defective-spot image sample; or, obtaining a sample defective-spot image which is vertically symmetrical to the fourth defective-spot image sample; or changing the color of the fourth defective-spot image sample by adjusting the gray-scale value of each pixel in the fourth defective-spot image sample to obtain a sample defective-spot image; or randomly adjusting the size of the fourth defective-spot image sample, for example by scaling the fourth defective-spot image sample by twice to obtain a sample defective-spot image.

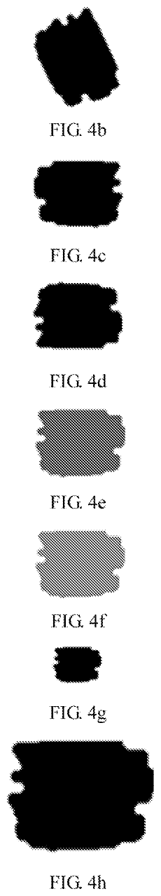

FIGS. 4a to 4h are schematic diagrams showing a plurality of sample defective-spot images in an embodiment of the present disclosure. The plurality of sample defective-spot images in different types include at least one of followings: as shown in FIG. 4a, the fourth defective-spot image sample, which is a defective-spot image in the third defective-spot image sample; as shown in FIG. 4b, an image obtained by rotating the fourth defective-spot image sample by a preset angle; as shown in FIG. 4c, an image which is horizontally symmetrical to a fourth defective-spot image sample; as shown in FIG. 4d, an image which is vertically symmetrical to the fourth defective-spot image sample; as shown in FIGS. 4e and 4f, images having colors in different gray-scales from the fourth defective-spot image sample; as shown in FIG. 4g, the fourth defective-spot image sample scaled down by the preset size, which is an image obtained by scaling down the fourth defective-spot image sample by the preset size scale; as shown in FIG. 4h, an image obtained by scaling up the fourth defective-spot image sample by the preset size.

At step S24, the data augmentation process is further performed on defective-spots close to the real scene simulated in step S23, so that the types of the defective-spot can be improved, and the number of sample defective-spot images can be increased, thereby improving the defective-spot samples in the second training data set, and solving the problem of fewer defective-spot materials in the real scene. A large number of sample training images containing defective-spots can be generated by using numbers of sample defective-spot images and combining the sample detection images, and the number of negative sample training samples of the model can be increased by using the sample training images containing the defective-spots, so that the accuracy of the defective-spot detection model can be improved when the training is finished.

In order to facilitate understanding of the process of simulating a defective-spot in steps S21 to S24, the process of simulating a defective-spot will be further described with an overall flow. FIG. 5 is a schematic flow chart of automatically simulating a defective-spot in an embodiment of the present disclosure. As shown in FIG. 5, generating a first defective-spot image sample through a grid dyeing method; generating a second defective-spot image sample through an image expansion algorithm; generating a third defective-spot image sample through a median filtering algorithm; obtaining a fourth defective-spot image sample through an edge cutting algorithm; and obtaining a sample defective-spot image through a data augmentation process, such as random symmetry, random angle rotation, random gray color, or random size adjustment.

The above is a complete description for the training method of the defective-spot detection model.

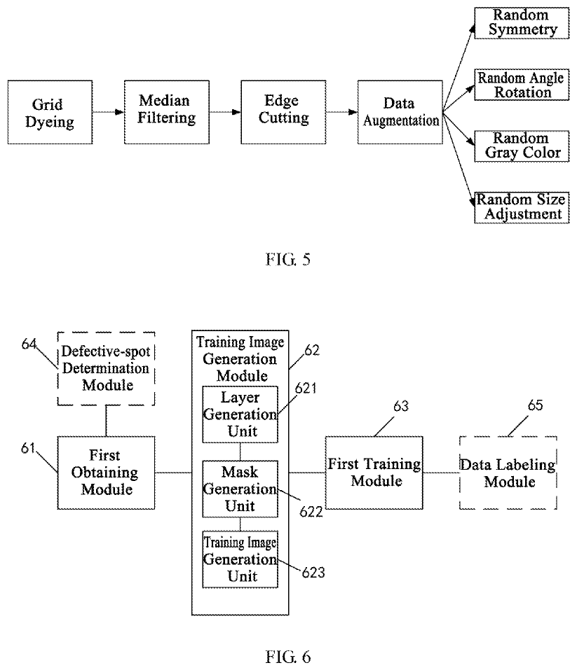

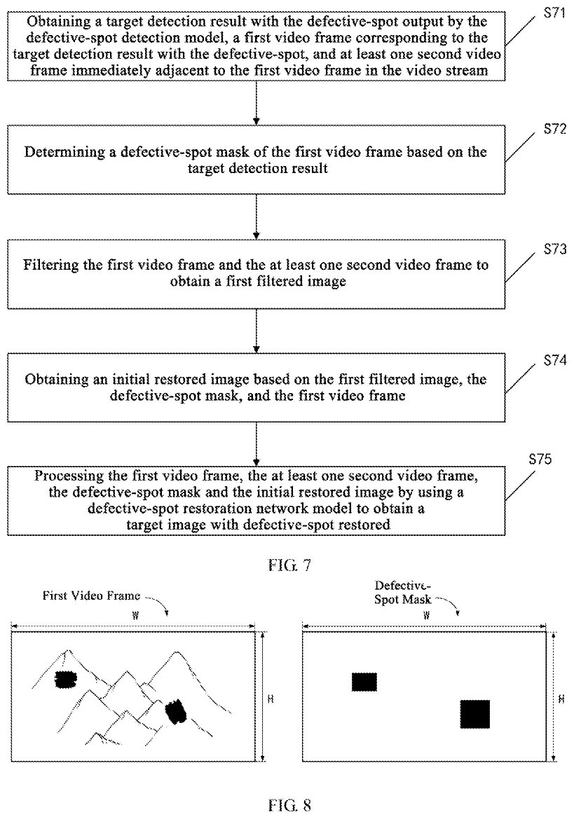

An embodiment of the present disclosure further provides a training device of a defective-spot detection model corresponding to the training method of the defective-spot detection model, and the principle of solving the problem of the training device of the defective-spot detection model is similar to that of the training method of the defective-spot detection model, so the implementation of the training device may refer to the implementation of the training method, and the repeated parts will not be described again. FIG. 6 is a schematic diagram showing of a training device of a defective-spot detection model in an embodiment of the present disclosure. As shown in FIG. 6, the training device of the defective-spot detection model includes a first obtaining module 61, a training image generation module 62, and a first training module 63.

The first obtaining module 61 is configured to obtain a first training data set and a second training data set generated in advance; the first training data set includes a plurality of frames of sample detection images, and the second training data set includes a plurality of frames of sample defective-spot images.

It should be noted that the first obtaining module 61 in the embodiment of the present disclosure is configured to execute step S11 in the training method of the defective-spot detection model described above.

The training image generation module 62 is configured to process each frame of sample detection image by using at least one of the plurality of frames of sample defective-spot images to generate a frame of sample training image.

It should be noted that the training image generation module 62 in the embodiment of the present disclosure is configured to execute step S12 in the training method of the defective-spot detection model described above.

The first training module 63 is configured to train the defective-spot detection model by using a plurality of frames of sample training images until a loss value converges, so as to obtain a trained defective-spot detection model.

It should be noted that the first training module 63 in the embodiment of the present disclosure is configured to execute step S13 in the training method of the defective-spot detection model described above.

The training image generation module 62 includes a layer generation unit 621, a mask generation unit 622, and a training image generation unit 623. The layer generation unit 621 is configured to generate a transparent layer based on a resolution of the sample detection image. It should be noted that the layer generation unit 621 in the embodiment of the present disclosure is configured to execute step S12-1 in the training method of the defective-spot detection model described above.

The mask generation unit 622 is configured to replace the image in the certain region of the transparent layer based on at least one of the plurality of frames of sample defective-spot images to generate a frame of transparent mask. It should be noted that the mask generation unit 622 in the embodiment of the present disclosure is configured to execute step S12-2 in the training method of the defective-spot detection model described above.

The training image generation unit 623 is configured to generate a sample training image having the defective-spot based on a frame of the transparency mask and the sample detection image. It should be noted that the training image generation unit 623 in the embodiment of the present disclosure is configured to execute step S12-3 in the training method of the defective-spot detection model described above.

In some embodiments, the training device of the defective-spot detection model further includes a defective-spot determination module 64 in addition to the above functional modules. The defective-spot determination module 64 includes a first defective-spot determination unit, a second defective-spot determination unit, a third defective-spot determination unit, and a defective-spot image determination unit. The first defective-spot determination unit is configured to generate defective-spot image data in a target region of a preset image by using a grid dyeing method to obtain a first defective-spot image sample. It should be noted that the first defective-spot determination unit in the embodiment of the present disclosure is configured to execute step S21 in the training method of the defective-spot detection model described above.

The second defective-spot determination unit is configured to perform an image dilation process on the first defective-spot image sample to obtain a second defective-spot image sample. It should be noted that the second defective-spot determination unit in the embodiment of the present disclosure is configured to execute step S22 in the training method of the defective-spot detection model described above.

The third defective-spot determination unit is configured to perform a median filtering process on the second defective-spot image sample to obtain a third defective-spot image sample, and determine edge position information of the third defective-spot image sample. It should be noted that the third defective-spot determination unit in the embodiment of the present disclosure is configured to execute step S23 in the training method of the defective-spot detection model described above.

The defective-spot image determination unit is configured to extract defective-spot image data based on the edge position information of the third defective-spot image sample to obtain a sample defective-spot image. It should be noted that the defective-spot image determination unit in the embodiment of the present disclosure is configured to execute step S24 in the training method of the defective-spot detection model described above.

In some embodiments, the first defective-spot determination unit is specifically configured to determine any two positions in each of multiple rows of pixels within the target region to generate a line segment with a preset width; and sequentially processing each row of pixels throughout all of multiple rows of pixels to obtain multiple line segments, so as to obtain the first defective-spot image sample.

In some embodiments, the third defective-spot determination unit is specifically configured to obtain a median filter kernel; for each pixel in the second defective-spot image sample, determine a target gray-scale value of a middle pixel corresponding to the median filter kernel, based on the gray-scale values of the pixels corresponding to the median filter kernel, so as to obtain the third defective-spot image sample. The third defective-spot determination unit is further configured to sequentially determine the target pixel with a preset gray-scale value in each row of pixels, throughout all of multiple rows of pixels of the third defective-spot image sample; and determine the edge position information of the third defective-spot image sample based on the position information of the target pixel.

In some embodiments, the defective-spot image determination unit is specifically configured to extract defective-spot image data based on the edge position information of the third defective-spot image sample to obtain a fourth defective-spot image sample; perform data processing on the fourth defective-spot image sample to obtain a plurality of sample defective-spot images in different types, where the plurality of sample defective-spot images in different types includes at least one of followings: the fourth defective-spot image sample; an image obtained by rotating the fourth defective-spot image sample by a preset angle; an image horizontally symmetrical to the fourth defective-spot image sample; an image vertically symmetrical to the fourth defective-spot image sample; images obtained by differently change the gray scale of the fourth defective-spot image sample; and images obtained by scaling the fourth defective-spot image sample according to a preset size proportion.

In some embodiments, the mask generation unit 622 is specifically configured to determine a certain region in the transparent layer based on a resolution of at least one of the plurality of frames of sample defective-spot images; and replace an image in the certain region of the transparent layer with the at least one of the plurality of frames of sample defective-spot images to generate a frame of transparent mask. It should be noted that the mask generation unit 622 in the embodiment of the present disclosure is configured to execute step S12-2 in the training method of the defective-spot detection model described above.

In some embodiments, the training device of the defective-spot detection model further includes a data labeling module 65 in addition to the aforementioned functional modules. The data labeling module 65 is configured to generate a piece of label data based on at least one of the plurality of frames of the sample defective-spot image and the transparent layer. It should be noted that the data labeling module 65 in the embodiment of the present disclosure is configured to execute the step of generating label data in the training method of the defective-spot detection model described above.

The first training module 63 is specifically configured to train the defective-spot detection model by using the plurality of frames of sample training images and a plurality of pieces of label data until the loss value converges, so as to obtain a trained defective-spot detection model. It should be noted that the first training module 63 in the embodiment of the present disclosure is specifically configured to execute step S13 in the training method of the defective-spot detection model described above.

With the defective-spot detection model trained by applying the training method of the defective-spot detection model, an embodiment of the present disclosure further provides a defective-spot detection method including: obtaining a video stream; performing a defective-spot detection process on each video frame in the video stream by using the defective-spot detection model to obtain an object detection result of each video frame. The defective-spot detection model trained by using the training method of the defective-spot detection model is used for defective-spot detection, so that the accuracy of the object detection result can be improved.

In specific implementation, the video stream to be detected is input to the trained defective-spot detection model, and the object detection result output by the defective-spot detection model is obtained. The object detection result includes the confidence level of detection and the label information of the detected defective-spot. The structure of the label information is the same as that of the pre-labeled label data, namely [id, (x1+w/2)/W, (y1+h/2)/H, w/W, h/H], where (x1+w/2)/W represents a percentage of an abscissa of a central position of the defective-spot image to an abscissa of the whole video frame, (y1+h/2)/H represents a percentage of an ordinate of the central position of the defective-spot image to an ordinate of the whole video frame, w/W represents a percentage of a length of the defective-spot image to a length of the video frame, and h/H represents a percentage of a height of the defective-spot image to a height of the video frame. When a plurality of defective-spots exist in the video frame, the object detection result includes pieces of label information corresponding to the plurality of defective-spots. The confidence level represents a probability of the presence of the defective-spot in a position indicated by the label information output from the defective-spot detection model. The confidence threshold is selected according to actual conditions. For example, the confidence threshold is selected as T. If the output confidence level is greater than or equal to T, it is determined that a defective-spot exists at a position indicated by the label information in the object detection result; if the output confidence level is smaller than T, it is determined that no defective-spot exists at the position indicated by the label information in the object detection result.

An embodiment of the present disclosure further provides a defective-spot detection device corresponding to the defective-spot detection method. The defective-spot detection device is configured to obtain a video stream; performing a defective-spot detection process on each video frame in the video stream by using the defective-spot detection model to obtain an object detection result of each video frame. The principle of solving the problem of the defective-spot detection device is similar to that of the defective-spot detection method, so the implementation of the defective-spot detection device may refer to the implementation of the defective-spot detection method, and repeated parts will not be described again.

when the object detection result indicates that the video frame has the defective-spot, the video frame with the defective-spot may be automatically restored. An embodiment of the present disclosure further provides a defective-spot restoration method which is executed by a defective-spot restoration device integrated with a defective-spot restoration network model. FIG. 7 is a flowchart of a method for restoring a defective-spot in an embodiment of the present disclosure. As shown in FIG. 7, the method includes steps S71 to S75.

At step S71, obtaining a target detection result with the defective-spot output by the defective-spot detection model, a first video frame corresponding to the target detection result with the defective-spot, and at least one second video frame immediately adjacent to the first video frame in the video stream.

Each target detection result corresponds to a video frame. When the target detection result indicates that a defective-spot exists, the corresponding video frame has a defective-spot. The video frame corresponding to the target detection result with the defective-spot serves as a first video frame, that is, the first video frame is a video frame with the defective-spot. Subsequently, a defective-spot restoration process is performed on the first video frame with the defective-spot by using a defective-spot restoration model.

The video stream in the step is the video stream acquired in the above-described defective-spot detection method. A second video frame adjacent to the first video frame is a video frame immediately before and after the first video frame in the video stream. Herein, one frame adjacent to the first video frame may serve as the second video frame, for example, an immediately previous frame before the first video frame or a next frame after the first video frame. Alternatively, multiple frames adjacent to the first video frame may serve as the second video frames. For example, two second video frames immediately before the first video frame and two second video frames after the first video frame may serve as the second video frame, so that three video frames may be obtained. Alternatively, two second video frames before the first video frame and two second video frames after the first video frame may serve as the second video frame, so that five video frames may be obtained. Alternatively, three second video frames before the first video frame and three second video frames after the first video frame may serve as the second video frame, so that seven video frames may be obtained.

The display data of the second video frame(s) before and/or after the first video frame is similar to the display data of the intermediate frame (i.e., the first video frame), and the defective-spots in the first video frame are restored by using the acquired multiple second video frames, so that the authenticity of the repair result can be improved.

At step S72, determining a defective-spot mask of the first video frame based on the target detection result.

The target detection result includes the label information of the defective-spot. The defective-spot mask is generated based on the label information of the defective-spot. The resolution of the defective-spot mask is the same as that of the first video frame. The position of the defective-spot in the defective-spot mask is the position of the defective-spot in the first video frame. The background of the defective-spot mask is pure white with a gray-scale value of 255, which may be normalized as a gray-scale value of 1; the foreground is the defective-spot (i.e., black) with a gray-scale value of 0, and the foreground is a region indicated by the label information of the defective-spot.

FIG. 8 is a schematic diagram showing comparison between a first video frame and a defective-spot mask in an embodiment of the present disclosure. As shown in FIG. 8, an embodiment in which a target detection result includes two defective-spots is taken as an example. According to a resolution of the first video frame, determining a pure white background image with the same resolution as that of the first video frame; determining minimum rectangular regions where the two defective-spots are located in the pure white background image by using the label information of the two defective-spots; and replacing the gray-scale values of the white background image in the minimum rectangular regions with black gray-scale values of the two defective-spots to obtain the defective-spot mask.

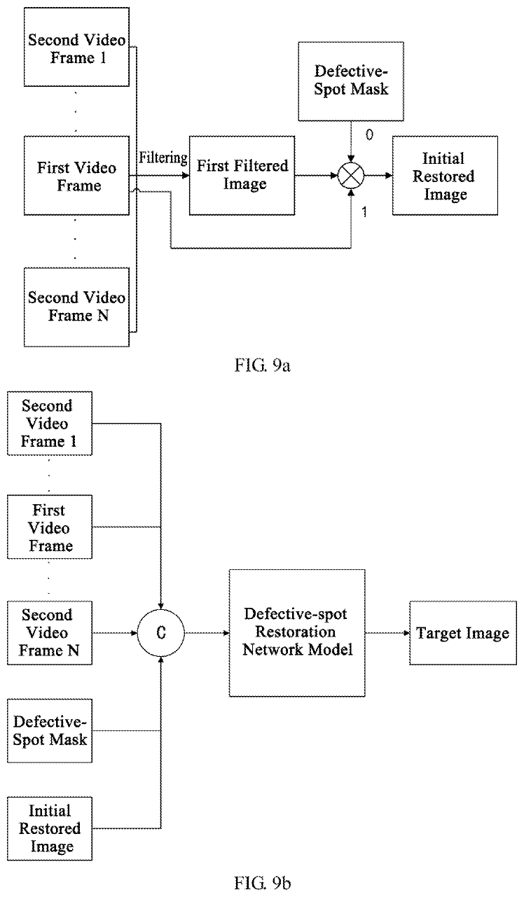

FIG. 9a is a schematic flowchart for determining an initial restored image in an embodiment of the present disclosure, and the following steps S73 and S74 are specifically shown in FIG. 9a.

At step S73, filtering the first video frame and the at least one second video frame to obtain a first filtered image.

In specific implementation, when the number of the second video frames is an odd number (however the timing sequence of the second video frames is not limited), for the position of the same pixel, sorting the gray-scale values of the same pixel in the first video frame and all the second video frame from small to large; averaging two gray-scale values in the middle of the sorted gray-scale values, such that the average value serves as a target gray-scale value of the pixel; and sequentially processing each pixel throughout all the pixels to determine the target pixel values of the pixels, so as to determine a first filtered image. The first filtered image is an image formed by the target pixel values of the pixels.

When the number of the second video frames is an even number (however the timing sequence of the second video frames is not limited), a median filtering process may be used for image processing. Specifically, for the position of the same pixel, sorting the gray-scale values of the same pixel in the first video frame and all the second video frame from small to large, taking the gray-scale value in the middle of the sorted gray-scale values as a target gray-scale value of the pixel; and sequentially processing each pixel throughout all the pixels to determine the target pixel value of each pixel so as to determine a first filtered image. The first filtered image is an image formed by the target pixel values of the pixels.

In some embodiments, the timing sequence of the multiple second video frames is defined. In particular, the second video frame includes N frames, wherein N/2 second video frames are video frames immediately before and adjacent to the first video frame, and N/2 second video frames are video frames immediately after and adjacent to the first video frame; n is an even number greater than 0.

A median filtering process may be used for image processing. For the position of the same pixel, sorting the gray-scale values of the same pixel in the first video frame and all the second video frame from small to large; taking the gray-scale value (i.e., an intermediate value) in the middle of the sorted gray-scale values as the target gray-scale value of the pixel; and processing each of all the pixels in the first video frame and each second video frame, so as to determine a first filtered image based on the target pixel values of the pixels. The first filtered image is an image formed by the target pixel values of the pixels.

It is to be noted that, at the same pixel, when a first video frame has a defective-spot, the gray-scale value of pixel where the defective-spot is located is minimum and equal to 0. The second video frame adjacent to the first video frame may or may not have a defective-spot. When the gray-scale values of the same pixel in each video frame are the same and equal to 0, in this case the defective-spot cannot be restored by performing a filtering process. When the gray-scale values of the same pixel in each video frame are different from each other, the intermediate value is not 0, so that the intermediate value may be used as the target gray-scale value of the pixel, thereby realizing the defective pixel repair of the pixel (i.e., the gray-scale value of the pixel is not 0 anymore). Follow above steps, the defective-spot restoration process is performed on each pixel with defective-spot data to obtain the first filtered image with the defective-spot primarily restored. Due to the fact that the gray-scale values of the pixels are updated, the first filtered image has a double image, and the display data of other portion (i.e., non-defective-spot portion) of the first video frame other than the defective-spots needs to be further restored, which will be illustrated in step S74.

In the method describe above, the defective-spots in the first video frame are restored by using the adjacent N second video frames before and after the first video frame, so that the display picture at the defective-spot is approximately restored to be the picture in the second video frame, thereby improving the reliability and the authenticity of the subsequent defective-spot restoration result.

At step S74, obtaining an initial restored image based on the first filtered image, the defective-spot mask, and the first video frame.

In specific implementation, based on the position information of the defective-spot image in the defective-spot mask, replacing the region image indicated by the position information of the defective-spot image in the first video frame with the region image indicated by the position information of the defective-spot image in the first filtered image, so as to obtain an initial restored image. That is, according to the position information of the defective-spot image in the defective-spot mask, extracting the a part of image at the defective-spot position from the first filtered image, combining the extracted image with the image of the non-defective-spot position extracted from the first video frame to form a new image as the initial restored image, which may be specifically referred to as formula 2.

The defective-spot image in the defective-spot mask is a foreground image with a gray-scale value of 0, and the non-defective-spot portion is a background image with a normalized gray-scale value of 1. The position information of the defective-spot image is the position of the foreground image indicated by the label information.

Median0=MASK2×CeterI+|MASK2−1|×MedianI formula 2

Wherein Median0 represents the initial restored image; MASK2 represents the defective-spot mask; CeterI represents the first video frame; and MedianI represents the first filtered image.

The initial restored image obtained is an image with the defective-spot initially removed, which is similar to the display picture of the first video frame. The initial restored image is optimized by using the subsequent step S75 to remove the double image at the position of the defective-spot, so as to obtain a true and reliable defective-spot restoration result.

At step S75, processing the first video frame, the at least one second video frame, the defective-spot mask and the initial restored image by using a defective-spot restoration network model to obtain a target image with defective-spot restored.

FIG. 9b is a schematic flow diagram for determining a target image in an embodiment of the present disclosure. As shown in FIG. 9b, processing the data of each pixel in each of the first video frame, the at least one second video frame, the defective-spot mask, and the initial restored image by using a splicing function concat (denoted as C), to obtain the input data. Specifically, the splicing function concat splices and combines channels of the same pixel of the frames of images to obtain multi-channel feature data, that is, the input data of the defective-spot restoration network model.

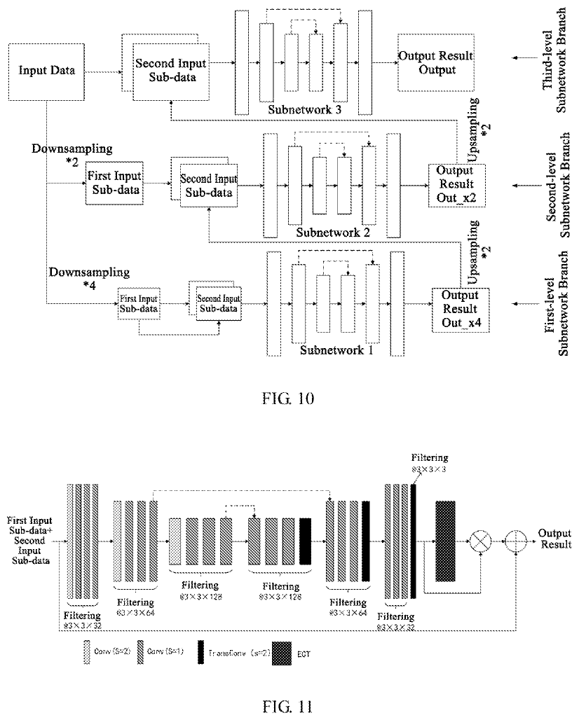

FIG. 10 is a schematic flow chart showing data processing performed by a defective-spot restoration network model in an embodiment of the present disclosure. As shown in FIG. 10, inputting the input data into the defective-spot restoration network model; and performing a downsampling process of different sizes on the input data, so as to obtain first input sub-data corresponding to a subnetwork branch of the defective-spot restoration network model. FIG. 10 shows three subnetwork branches, wherein the first-level subnetwork branch is a subnetwork branch with downsampling of 4 times, and the second-level subnetwork branch is a subnetwork branch with downsampling of 2 times.

It should be noted that each subnetwork branch has two input data. Specifically, the input data of the first-level subnetwork branch are two first input sub-data which are the same as each other. Each of other subnetwork branches except the first-level subnetwork branch performs an upsampling process on the output data of the subnetwork branch immediately previous the subnetwork branch, and takes the upsampling result as second input sub-data of the current subnetwork branch, so as to obtain the target image output by the last subnetwork branch. A resolution of the feature map corresponding to the first input sub-data of each subnetwork branch is smaller than a resolution of the feature map corresponding to the first input sub-data of the subnetwork branch immediately after the subnetwork branch.

For example, as shown in FIG. 10, the first input data of the first-level subnetwork branch includes the first input sub-data obtained by performing 4 times downsampling on the input data output by the splicing function concat, and the second input data which is the same as the first input data. The first input data of the second-level subnetwork branch includes the first input sub-data obtained by performing 2 times downsampling on the input data output by the splicing function concat, and the second input data obtained by performing 2 times upsampling on the data output by the first-level subnetwork branch. The first input data of the third-level subnetwork branch includes the input data output by the splicing function concat, and the second input data obtained by upsampling 2 times the data output by the second-level subnetwork branch.

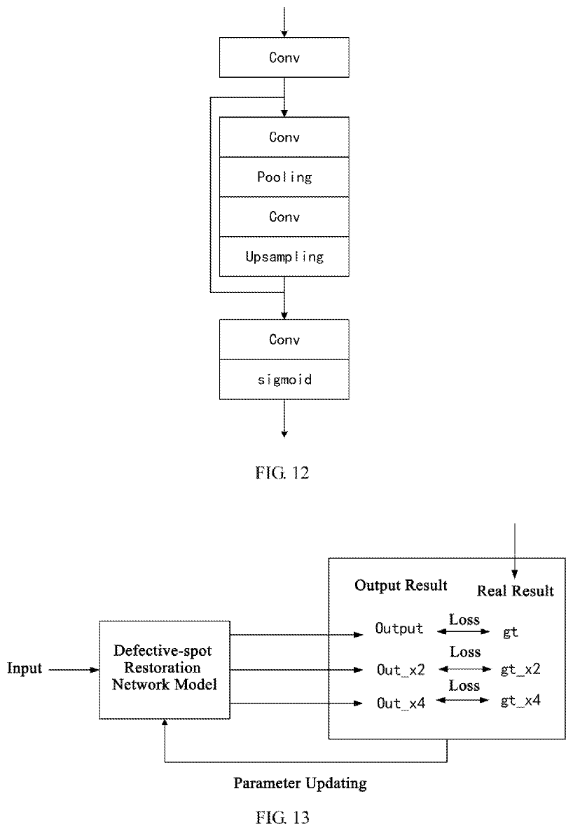

The data output by the first-level subnetwork branch is a repair result obtained by reducing, by four times, the resolution of the input data (i.e., the feature map) output by the splicing function concat; the data output by the second-level subnetwork branch is a repair result obtained by reducing, by two times, the resolution of the input data (i.e., the feature map) output by the splicing function concat. In FIG. 10, the sub-network 1, the sub-network 2, and the sub-network 3 have the same model structure, but the sub-network 1, the sub-network 2, and the sub-network 3 do not have model parameters that may be shared with each other. FIG. 11 is a schematic diagram of specific structures of models of a sub-network 1, a sub-network 2 and a sub-network 3 in an embodiment of the present disclosure. As shown in FIG. 11, Conv represents a convolutional layer, Conv (s=1) represents a convolutional layer with a step size of 1; and conv (s=2) represents a convolutional layer, with a step size of 2 and downsampling twice the resolution. TransConv represents a deconvolution layer, and TransConv (s=2) represents the deconvolution layer, with a step size of 2 and upsampling twice the resolution. ECA represents an attention module, and a specific model structure of the attention module is shown in FIG. 12. FIG. 12 is a schematic diagram of a model structure of an exemplary attention module in an embodiment of the present disclosure. As shown in FIG. 12, pooling represents a pooling process; upsampling represents an upsampling process; sigmoid represents an activation function. With the network architectures shown in FIGS. 10 to 12, the input data output by the splicing function concat is processed to obtain the target image with the defective-spot restored, that is, the image of the first video frame in which the defective-spot is restored.

In the embodiments of the present disclosure, the first filtered image is combined with the defective-spot mask, so that defective-spot in the image can be restored. Not only the defective-spot in the video frame can be accurately restored, but also the degree of restoration of the displayed frame of the target image can be improved.

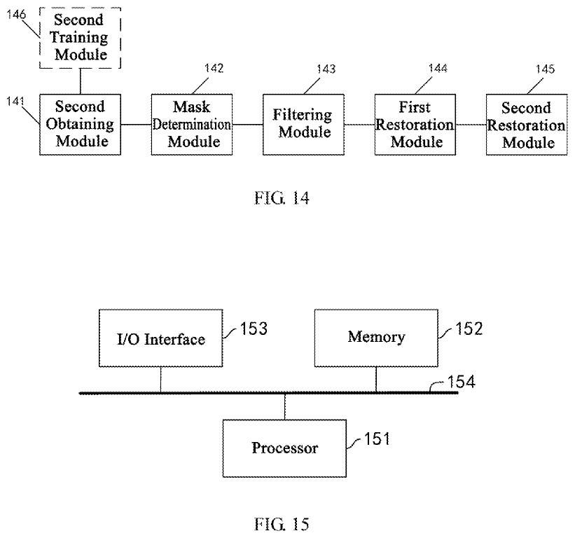

In some embodiments, FIG. 13 is a schematic flow chart of parameter updating of a loss function calculation model in an embodiment of the present disclosure. As shown in FIG. 13, for each level of subnetwork branch, a loss is calculated according to an output result output by each level of subnetwork branch. In the embodiment of the present disclosure, calculating the losses of the output results of the levels of subnetwork branch in combination with a Mean Absolute Error L1 Loss, a Perceptual Loss, and a Style Loss; weighting the losses of the output results of the levels of subnetwork branch to obtain a target weighted loss value of the entire defective-spot restoration network model; and updating parameters based on the target weighted loss value to train the defective-spot restoration network model.

It should be noted that the training data set of the defective-spot restoration network model may adopt the sample training images obtained in the method for training the defective-spot detection model, and the number of negative sample training samples of the model is increased by using the large number of sample training images containing defective-spots, so that the accuracy of the defective-spot detection model can be improved when training is completed.

Specifically, the training step of the defective-spot restoration network model includes steps S701 to S708.

At step S701, determining a first loss value of an image with a defective-spot (i.e., a defective-spot image) and a second loss value of an image without a defective-spot (i.e., a non-defective-spot image/defective-spot-free image) in an output result of each of the levels of subnetwork branch, based on the defective-spot mask, the output result and a real result corresponding to the output result.

As shown in FIG. 13, for each of the output result Out_x4 of the first-level subnetwork branch, the output result Out_x2 of the second-level subnetwork branch, and the output result Output of the third-level subnetwork branch, calculating the first loss value and the second loss value of each of the output results Out_x4, Out_x2, and Output.

It should be noted that, the output result indicates the defective-spot restored image of the video frame output by the subnetwork branch which has not yet been trained. Since the defective-spot restoration network model has not yet been trained, the defective-spot restoration effect of the defective-spot restored image is poor. The real result corresponding to the output result indicates an image with the defective-spot well restored in the same video frame. Determining a loss value of each level of subnetwork branch according to a difference between the output result and the real result, wherein the loss value includes two parts, that is, a first loss value and a second loss value. The first loss value corresponds to the defective-spot portion, and the first loss value is determined according to the difference between the output result and the real result. The second loss value corresponds to the non-defective-spot portion, the second loss value is determined according to a difference between the output result and the real result.

The formula for calculating L1 loss is as follows: L₁(x,y)=Σ_{i=0,j=0}^{M1,M2}|x_{i,j}−y_{i,j}|, denoted as ∥₁, where i and j represent the coordinates of pixels; M1 represents the maximum coordinate value in a row direction of pixels, and M2 represents the maximum coordinate value in a column direction of pixels; x_{i,j} represents the grayscale value of pixel (i, j) in the output result; y_{i,j} represents the grayscale value of pixel (i, j) in the real result.

For the defective-spot portion, calculating the first loss value L_{1,valid} (Iₒᵤₜ, I_{gt}) according to formula 3 as follow.

$${L}_{1 , valid} ( {I}_{out} , {I}_{gt} ) = \frac{1}{W 1} {\vert ( 1 - MASK 3 ) \times ( {I}_{out} - {I}_{gt} ) \vert}_{1} \qquad formula 3$$

Iₒᵤₜ represents the output result; I_{gt} represents the real result; MASK3 represents the defective-spot mask corresponding to the video frame input to the defective-spot restoration network model during the training process; W1 represents the total number of pixels in the defective-spot portion of MASK3.

For the non-defective-spot portion, calculating the second loss value L_{1,background} (Iₒᵤₜ, I_{gt}) according to formula 4 as follow.

$${L}_{1 , background} ( {I}_{out} , {I}_{gt} ) = \frac{1}{W 2} {\vert MASK 3 \times ( {I}_{out} - {I}_{gt} ) \vert}_{1} \qquad formula 4$$

Iₒᵤₜ represents the output result; I_{gt} represents the real result; MASK3 represents the defective-spot mask corresponding to the video frame input to the defective-spot restoration network model during the training process; W2 represents the total number of pixels in the non-defective-spot portion of MASK3.

At step S701, the loss values (i.e., the first loss value and the second loss value) of the defective-spot portion and the non-defective-spot portion are calculated respectively. As compared with a method in which the loss of the whole output result is directly calculated in the conventional technology, the loss calculation method in the embodiment of the present disclosure can increase the attention of the defective-spot portion and improve calculation accuracy of the loss of the defective-spot portion.

At step S702, based on the position information of the defective-spot image in the defective-spot mask, replacing the region image indicated by the position information of the defective-spot image in the output result with the region image indicated by the position information of the defective-spot image in the real result, to obtain a first intermediate result.

Replacing the non-defective-spot portion in the output result with the real result, and reserving the output result for the defective-spot portion, according to the formula 5 below.

$${I}_{mask} = MASK 3 \times {I}_{gt} + \vert MASK 3 - 1 \vert \times {I}_{out} \qquad formula 5$$

At step S703, inputting the first intermediate result, the output result and the real result corresponding to the output result into the convolutional neural network, to obtain a first intermediate feature, a second intermediate feature and a third intermediate feature; and determining a third loss value based on the first intermediate feature, the second intermediate feature and the third intermediate feature.

In the step, the third loss value Lₚ(Iₒᵤₜ, I_{gt}) of the output result of the each level of subnetwork branch is calculated based on the Perceptual loss according to the following formula:

$${L}_{P} ( {I}_{out} , {I}_{gt} ) = {\sum }_{0}^{P - 1} {\vert {f}_{p} ( {I}_{out} ) - {f}_{p} ( {I}_{gt} ) \vert}_{1} + {\sum }_{0}^{P - 1} {\vert {f}_{p} ( {I}_{mask} ) - {f}_{p} ( {I}_{gt} ) \vert}_{1}$$

fₚ represents the feature output of the intermediate layer in the convolutional neural network VGG. P represents the number of layers of the intermediate layer. fₚ(Iₘₐₛₖ) represents the first intermediate feature, fₚ(Iₒᵤₜ) represents the second intermediate feature, fₚ(I_{gt}) represents the third intermediate feature.

At step S704, performing a matrix transformation on the first intermediate feature, the second intermediate feature and the third intermediate feature to obtain a first transformation result, a second transformation result and a third transformation result.

Performing a Gram matrix transformation on the first intermediate feature fₚ(Iₘₐₛₖ) to obtain the first transformation result Gfₚ(Iₘₐₛₖ); performing a Gram matrix transformation on the second intermediate feature fₚ(Iₒᵤₜ) to obtain the second transformation result Gfₚ(Iₒᵤₜ); and performing a Gram matrix transformation on the third intermediate feature fₚ(I_{gt}) to obtain the third transformation result Gfₚ(I_{gt}).

At step S705, determining a fourth loss value based on the first transformation result, the second transformation result, and the third transformation result.

In the step, the fourth loss value L_{S}(Iₒᵤₜ, I_{gt}) of the output result of each level of subnetwork branch is calculated based on the Style loss according to the following formula.

$${L}_{S} ( {I}_{out} , {I}_{gt} ) = {\sum }_{0}^{P - 1} {\vert {Gf}_{p} ( {I}_{out} ) - {Gf}_{p} ( {I}_{gt} ) \vert}_{1} + {\sum }_{0}^{P - 1} {\vert {Gf}_{p} ( {I}_{mask} ) - {Gf}_{p} ( {I}_{gt} ) \vert}_{1}$$

The definition of each parameter refers to the definition of each parameter in the calculation formula of the Perceptual loss, and the repeated description will not be described herein.

At step S706, a weighted loss value corresponding to each level of subnetwork branch is calculated by weighting the first loss value, the second loss value, the third loss value and the fourth loss value according to the following formula.

The calculation formula of the weighted loss value corresponding to each level of subnetwork branch is as follows:

$$LOSS = {W}_{V} = {L}_{1 , valid} + {W}_{b} \times {L}_{1 , background} + {W}_{P} \times {L}_{P} + {W}_{S} \times {L}_{S}$$

W_{V} represents a weighting coefficient of the first loss value, W_{b} represents a weighting coefficient of the second loss value, W_{b} represents a weighting coefficient of the third loss value, W_{S} represents a weighting coefficient of the fourth loss value. In an embodiment, W_{V}=6, W_{b}=1, Wₚ=0.05, W_{S}=120.

The weighted loss value for the first-level subnetwork branch is denoted as LOSS_1, the weighted loss value for the second-level subnetwork branch is denoted as LOSS_2, and the weighted loss value for the third-level subnetwork branch is denoted as LOSS 3.

At step S707, weighting the weighted loss values corresponding to the levels of subnetwork branch to obtain a target weighted loss value.

Specifically, the weighted loss values corresponding to the levels of subnetwork branch is weighted averagely to determine the target weighted loss value LOSS_0 according to the following formula.

$$LOSS\_ 0 = \frac{LOSS\_ 1 + LOSS\_ 2 + LOSS\_ 3}{3}$$

At step S708, continuously training the defective-spot restoration network model by performing a weighted back propagation process on the target weighted loss value until the target weighted loss value is converged, thereby obtaining the trained defective-spot restoration network model.

In steps S701 to S708, the weighted loss value LOSS of each level of subnetwork branch is calculated in combination with the L1 loss, the Perceptual loss, and the Style loss, so that the losses in various types during the model training process are fully considered, and the training precision of the model can be improved, and the defective-spot restoration precision of the defective-spot restoration network model can be improved.

The main executing body of the defective-spot detection method is a defective-spot detection model, and the main executing body of the defective-spot restoration method is a defective-spot restoration model. In the embodiment of the present disclosure, the defective-spot detection model may be integrated in a detection device and the defective-spot restoration model may be integrated in a restoration device. Alternatively, the defective-spot detection model and the defective-spot restoration model may be integrated in a detection and restoration device, so that the functions of the defective-spot detection and restoration can be integrated.

It will be understood by those of skill in the art that in the above method of the present embodiment, the order of the steps does not imply a strict order of execution and does not impose any limitations on the implementation, as the order of execution of the steps should be determined by their function and possibly inherent logic.

An embodiment of the present disclosure further provides a defective-spot restoration device corresponding to the defective-spot restoration method, and the principle of the defective-spot restoration device for solving the problem is similar to that of the defective-spot restoration method, so the implementation of the apparatus may refer to the implementation of the method, and the repeated parts will not be described again. FIG. 14 is a schematic diagram showing a defective-spot restoration device in an embodiment of the present disclosure. As shown in FIG. 14, the defective-spot restoration device includes a second obtaining module 141, a mask determination module 142, a filtering module 143, a first restoration module 144, and a second restoration module 145. The second obtaining module 141 is configured to obtain a target detection result of a defective-spot output by the defective-spot detection model, a first video frame corresponding to the target detection result of the defective-spot, and at least one second video frame adjacent to the first video frame in the video stream.

It should be noted that the second obtaining module 141 in the embodiment of the present disclosure is configured to execute step S71 in the above-mentioned defective-spot restoration method.

The mask determination module 142 is configured to determine a defective-spot mask for the target detection frame based on the target detection result.

It should be noted that the mask determination module 142 in the embodiment of the present disclosure is configured to execute step S72 in the above-mentioned defective-spot restoration method.

The filtering module 143 is configured to perform a filtering process on the first video frame and the at least one second video frame to obtain a first filtered image.

It should be noted that the filtering module 143 in the embodiment of the present disclosure is configured to execute step S73 in the above-mentioned defective-spot restoration method.

The first restoration module 144 is configured to obtain an initial restored image based on the first filtered image, the defective-spot mask, and the first video frame.

It should be noted that the first restoration module 144 in the embodiment of the present disclosure is configured to execute step S74 in the above-mentioned defective-spot restoration method.

The second restoration module 145 is configured to process the first video frame, the at least one second video frame, the defective-spot mask, and the initial restored image by using the defective-spot restoration network model to obtain a target image with the defective-spot restored.

It should be noted that the second restoration module 145 in the embodiment of the present disclosure is configured to execute step S75 in the above-mentioned defective-spot restoration method.

In some embodiments, the second video frame includes N frames, wherein N/2 second video frames are video frames immediately previous the first video frame, and the N/2 second video frames are video frames immediately after the first video frame; n is an even number greater than 0.

Specifically, the filtering module 143 is configured to, for the same pixel, sort the gray-scale values of the same pixel in the first video frame and all the second video frame from small to large, and take the middle grayscale value in sorted grayscale values as a target gray-scale value of the pixel; and determine a first filtered image based on the target pixel value of each pixel by processing each pixel throughout all pixels in the first video frame and all the second video frame.

It should be noted that, the filtering module 143 in the embodiment of the present disclosure is specifically configured to execute the specific implementation process of step S73 in the foregoing defective-spot restoration method.

In some embodiments, the first restoration module 144 is specifically configured to replace, based on the location information of the defective-spot image in the defective-spot mask, the region image indicated by the location information of the defective-spot image in the first video frame with the region image indicated by the location information of the defective-spot image in the first filtered image, so as to obtain an initial restored image.

It should be noted that, in the embodiment of the present disclosure, the first restoration module 144 is specifically configured to execute the specific implementation process of step S74 in the above-mentioned defective-spot restoration method.

In some embodiments, the second restoration module 145 is specifically configured to process data of each pixel in each of multiple video frames, the defective-spot mask, and the initial restored image, to obtain input data; inputting input data into a defective-spot restoration network model, and respectively performing downsampling process of different sizes on the input data to obtain first input sub-data corresponding to a subnetwork branch in the defective-spot restoration network model, wherein the input data of the first-level sub-network includes two pieces of first input sub-data that are the same as each other. For other subnetwork branches except the first-level subnetwork branch, an upsampling process is performed on the output data of the previous-level subnetwork branch, and the upsampling result serves as the second input sub-data of the current-level subnetwork branch, so as to obtain the target image output by the last-level subnetwork branch. The resolution of the feature map corresponding to the first input sub-data of the upper-level subnetwork branch is smaller than the resolution of the feature map corresponding to the first input sub-data of the lower-level subnetwork branch.

It should be noted that, in the embodiment of the present disclosure, the second restoration module 145 is specifically configured to execute the specific implementation process of step S75 in the above-mentioned defective-spot restoration method.

In some embodiments, the defective-spot restoration device includes a second training module 146 in addition to the various functional modules described above. The second training module 146 is configured to determine, for the output result of each of the levels of subnetwork branch, a first loss value of the defective-spot image and a second loss value of the non-defective-spot image in the output result, based on the defective-spot mask, the output result, and a real result corresponding to the output result; based on the position information of the defective-spot image in the defective-spot mask, replacing the region image indicated by the position information of the defective-spot image in the output result with the region image indicated by the position information of the defective-spot image in the real result, so as to obtain a first intermediate result; inputting the first intermediate result, the output result and the real result corresponding to the output result into a convolutional neural network to obtain a first intermediate feature, a second intermediate feature and a third intermediate feature; and determining a third loss value based on the first intermediate feature, the second intermediate feature and the third intermediate feature; performing specific matrix transformation process on the first intermediate feature, the second intermediate feature and the third intermediate feature to obtain a first transformation result, a second transformation result and a third transformation result, respectively; determining a fourth loss value based on the first transformation result, the second transformation result, and the third transformation result; weighting the first loss value, the second loss value, the third loss value and the fourth loss value to obtain weighted loss values corresponding to each level of subnetwork branch; weighting the weighted loss values corresponding to each level of subnetwork branch to obtain target weighed loss values; and continuously training the defective-spot restoration network model by performing a weighted back propagation process on the target weighted loss value until the target weighted loss value is converged, so as to obtain the trained defective-spot restoration network model.

It should be noted that, in the embodiment of the present disclosure, the second training module 146 is specifically configured to execute steps S701 to S708 in the above-mentioned defective-spot restoration method.

In an embodiment of the present disclosure, a computer device is further provided. FIG. 15 is a schematic diagram showing a structure of a computer device in an embodiment of the present disclosure. As shown in FIG. 15, an embodiment of the present disclosure provides a computer device including: one or more processors 151, memory 152, and one or more I/O interfaces 153. The memory 152 stores one or more programs which, when executed by the one or more processors, cause the one or more processors to implement the communication method as in any of the above embodiments; one or more I/O interfaces 153 are coupled between the processor and the memory and configured to enable information interaction between the processor and the memory.

The processor 151 is a device with data processing capability, which includes but is not limited to, a central processing unit CPU. The memory 152 is a device having data storage capability, which includes, but is not limited to, Random Access Memory (RAM), more specifically, Read-Only Memory (ROM), Electrically Erasable Programmable Read-Only Memory (EPROM), FLASH Memory (FLASH). The I/O interface (read/write interface) 153 is connected between the processor 151 and the memory 152, realizes information interaction between the processor 151 and the memory 152, and includes but is not limited to a data Bus (Bus) and the like.

In some embodiments, processor 151, memory 152, and I/O interface 153 are couple to each other through a bus 154, which in turn coupled to other components of the computer device.

According to an embodiment of the present disclosure, a computer non-transitory readable storage medium is further provided. The computer non-transitory readable storage medium stores thereon a computer program, and when executed by a processor, the computer program performs the steps in the training method of the defective-spot detection model in any one of the above embodiments; or, the computer program is executed by a processor to perform the steps of the defective-spot detection method as in any of the above embodiments; alternatively, the computer program is executed by a processor to perform the steps of the defective-spot restoration method as in any one of the above embodiments.

In particular, the processes described above with reference to the flow diagrams may be implemented as computer software programs, according to embodiments of the present disclosure. For example, embodiments of the present disclosure include a computer program product including a computer program embodied on a machine-readable medium, the computer program including program code for performing the method shown in the flow chart. In such an embodiment, the computer program may be downloaded and installed from a network via the communication section, and/or installed from a removable medium. The computer program performs the above-described functions defined in the system of the present disclosure when executed by a Central Processing Unit (CPU).

It should be noted that the computer non-transitory readable medium shown in the present disclosure may be a computer readable signal medium or a computer readable storage medium or any combination of the two. A computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to, an electrical connection having one or more wires, a portable computer diskette, a hard disk, a Random Access Memory (RAM), a Read-Only Memory (ROM), an Erasable Programmable Read-Only Memory (EPROM or flash Memory), an optical fiber, a portable Compact Disc Read-Only Memory (CD-ROM), an optical storage device, a magnetic storage device, or any suitable combination of the foregoing. In the present disclosure, a computer readable storage medium may be any tangible medium that can contain, or store a program for use by or in connection with an instruction execution system, apparatus, or device. In contrast, in the present disclosure, a computer-readable signal medium may include a propagated data signal with computer-readable program code embodied therein, for example, in baseband or as part of a carrier wave. Such a propagated data signal may take any of a variety of forms, including but not limited to, electro-magnetic, optical, or any suitable combination thereof. A computer readable signal medium may be any computer non-transitory readable storage medium that is not a computer readable storage medium and that may communicate, propagate, or transport a program for use by or in connection with an instruction execution system, apparatus, or device. Program code embodied on a computer non-transitory readable storage medium may be transmitted using any appropriate medium, including but not limited to, wireless, wire, fiber optic cable, RF, etc., or any suitable combination of the foregoing.

The flowchart and block diagrams in the figures illustrate the architecture, functionality, and operation of possible implementations of apparatus, methods and computer program products according to various embodiments of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the drawings. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood that the above embodiments are merely exemplary embodiments employed to illustrate the principles of the present disclosure, and the present disclosure is not limited thereto. It will be apparent to those skilled in the art that various changes and modifications can be made therein without departing from the spirit and essence of the present disclosure, and these changes and modifications are to be considered within the scope of the present disclosure.

1. A method for training a defective-spot detection model, comprising:
obtaining a first training data set and a second training data set; wherein the first training data set comprises a plurality of frames of sample detection images, and the second training data set comprises a plurality of frames of sample defective-spot images;
for each frame of sample detection image, processing the frame of sample detection image by using at least one of the plurality of frames of sample defective-spot images, to generate a frame of sample training image; and
training the defective-spot detection model by using the plurality of frames of sample training images until a loss value is converged, so as to obtain a trained defective-spot detection model; wherein
for each frame of sample detection image, processing the frame of sample detection image by using at least one of the plurality of frames of sample defective-spot images to generate a frame of sample training image, comprises:
generating a transparent layer based on a resolution of the sample detection image;
replacing an image in a certain region of the transparent layer based on at least one of the plurality of frames of sample defective-spot images, to generate a frame of transparent mask; and
generating the sample training image with a defective-spot based on the frame of transparent mask and the sample detection image.

2. The method of claim 1, wherein obtaining the second training data set comprises the plurality of frames of the sample defective-spot images, comprises:
generating defective-spot image data in a target region of a preset image by using a grid dyeing method, to obtain a first defective-spot image sample;
performing an image expansion process on the first defective-spot image sample to obtain a second defective-spot image sample;
performing a median filtering process on the second defective-spot image sample to obtain a third defective-spot image sample, and determining edge position information of the third defective-spot image sample; and
extracting the defective-spot image data based on the edge position information of the third defective-spot image sample to obtain the sample defective-spot image.

3. The method of claim 2, wherein generating the defective-spot image data in the target region of the preset image by using the grid dyeing method to obtain the first defective-spot image sample, comprises:
determining any two positions of each of multiple rows of pixels in the target region to generate a line segment with a preset width; and
sequentially processing each row of the multiple rows of pixels to obtain multiple line segments, so as to obtain the first defective-spot image sample.

4. The method of claim 2, wherein performing the median filtering process on the second defective-spot image sample to obtain the third defective-spot image sample, comprises:
obtaining a median filtering kernel; and
for each pixel in the second defective-spot image sample, determining a target gray-scale value of a middle pixel corresponding to the median filter kernel, based on the gray-scale values of the pixels corresponding to the median filter kernel, so as to obtain the third defective-spot image sample.

5. The method of claim 2, wherein determining the edge position information of the third defective-spot image sample, comprises:
throughout all rows of pixels of the third defective-spot image sample, sequentially determining a target pixel with a preset gray-scale value in each row of pixels; and
determining the edge position information of the third defective-spot image sample based on the position information of the target pixel.

6. The method of claim 2, wherein extracting the defective-spot image data based on the edge position information of the third defective-spot image sample to obtain the sample defective-spot image, comprises:
extracting the defective-spot image data based on the edge position information of the third defective-spot image sample, so as to obtain a fourth defective-spot image sample; and
performing data processing on the fourth defective-spot image sample to obtain of a plurality of sample defective-spot images in different types;
wherein the plurality of sample defective-spot images in different types comprises at least one of followings: the fourth defective-spot image sample; an image obtained by rotating the fourth defective-spot image sample by a preset angle; an image horizontal symmetrical to the fourth defective-spot image sample; an image vertically symmetrical to the fourth defective-spot image sample; the fourth defective-spot image samples with different gray colors; and the scaled fourth defective-spot image sample by a preset size proportion.

7. The method of claim 1, wherein replacing the image in the certain region of the transparent layer based on the at least one of the plurality of frames of sample defective-spot images to generate the frame of transparent mask, comprises:
determining the certain region of the transparent layer based on a resolution of the at least one of the plurality of frames of sample defective-spot images; and
replacing the image in the certain region of the transparent layer by using the at least one of the plurality of frames of sample defective-spot images to generate the frame of transparent mask.

8. The method of claim 1, wherein after generating the transparent layer based on the resolution of the sample detection image, the method further comprises:
generating a piece of label data based on the at least one of the plurality of frames of sample defective-spot images and the transparent layer; and
training the defective-spot detection model by using the plurality of frames of sample training images until the loss value is converged, so as to obtain the trained defective-spot detection model comprises:
training the defective-spot detection model by using the plurality of frames of sample training images and the plurality of pieces of label data until the loss value is converged, so as to obtain the trained defective-spot detection model.

9. (canceled)

10. A defective-spot detection method, applied to the defective-spot detection model trained by the method of claim 1; wherein the defective-spot detection method comprises:
obtaining a video stream; and
performing defective-spot detection on each video frame in the video stream by using the defective-spot detection model to obtain a target detection result of each video frame.

11. A method for restoring a defective-spot, comprising:
obtaining a target detection result with a defective-spot output by a defective-spot detection model, a first video frame corresponding to the target detection result with the defective-spot, and at least one second video frame adjacent to the first video frame in a video stream;
determining a defective-spot mask of the first video frame based on the target detection result;
filtering the first video frame and the at least one second video frame to obtain a first filtered image;
obtaining an initial restored image based on the first filtered image, the defective-spot mask and the first video frame; and
processing, by using a defective-spot restoration network model, the first video frame, the at least one second video frame, the defective-spot mask and the initial restored image, so as to obtain a target image with the defective-spot restored.

12. The method of claim 11, wherein the second video frame comprises N frames, wherein N/2 frames of the second video frame are previous video frames adjacent to the first video frame, and N/2 frames of the second video frame are subsequent video frames adjacent to the first video frame; n is an even number greater than 0;
filtering the first video frame and the at least one second video frame to obtain the first filtered image, comprises:
for a same pixel, sorting the gray-scale values of the same pixel in the first video frame and each of the at least one second video frame from small to large, and taking a middle gray-scale value of the sorted gray-scale values as a target gray-scale value of the pixel; and
processing each pixel throughout all pixel in the first video frame and each second video frame, to determine the first filtered image based on the target pixel value of each pixel.

13. The method of claim 11, wherein obtaining the initial restored image based on the first filtered image, the defective-spot mask and the first video frame comprises:
replacing an image in a region in the first video frame indicated by position information of a defective-spot image with an image in a region in the first filtered image indicated by the position information of the defective-spot image, based on the position information of the defective-spot image in the defective-spot mask, to obtain the initial restored image.

14. The method of claim 11, wherein processing, by using the defective-spot restoration network model, the first video frame, the at least one second video frame, the defective-spot mask and the initial restored image, so as to obtain the target image with the defective-spot restored, comprises:
processing data of each pixel in each of the first video frame, the at least one second video frame, the defective-spot mask and the initial restored image to obtain input data;
inputting the input data into the defective-spot restoration network model, and respectively performing downsampling process of different sizes on the input data to obtain first input sub-data corresponding to a subnetwork branch in the defective-spot restoration network model;
wherein the input data of a first-level subnetwork branch comprises two pieces of same first input sub-data; each of other subnetwork branches except the first-level subnetwork branch performs an upsampling process on output data of the previous-level subnetwork branch and receives the upsampling result as second input sub-data of the subnetwork branch, to obtain the target image output by a last-level subnetwork branch; a resolution of a feature map corresponding to the first input sub-data of an upper-level subnetwork branch is smaller than a resolution of a feature map corresponding to the first input sub-data of a lower-level subnetwork branch.

15. The method of claim 14, further comprising: training the defective-spot restoration network model, which comprises:
for output result of each level of subnetwork branch, determining a first loss value of a defective-spot image and a second loss value of a non-defective-spot image in the output result based on the defective-spot mask, the output result and a real result corresponding to the output result;
replacing an image in a region in the output result indicated by position information of the defective-spot image with an image in a region in the real result indicated by the position information of the defective-spot image, based on the position information of the defective-spot image in the defective-spot mask, so as to obtain a first intermediate result;
inputting the first intermediate result, the output result and the real result corresponding to the output result into a convolutional neural network to obtain a first intermediate feature, a second intermediate feature and a third intermediate feature, and determining a third loss value based on the first intermediate feature, the second intermediate feature and the third intermediate feature;
performing a specific matrix transformation on the first intermediate feature, the second intermediate feature and the third intermediate feature to obtain a first transformation result, a second transformation result and a third transformation result, respectively;
determining a fourth loss value based on the first transformation result, the second transformation result, and the third transformation result;
weighting the first loss value, the second loss value, the third loss value and the fourth loss value to obtain a weighted loss value corresponding to each level of subnetwork branch;
weighting the weighted loss value corresponding to each level of subnetwork branch to obtain a target weighted loss value; and
continuously training the defective-spot restoration network model by performing weighted back propagation on the target weighted loss value, until the target weighted loss value is converged, to obtain the trained defective-spot restoration network model.

16. A defective-spot restoration device performing the method of claim 11, the defective-spot restoration device comprising: a second obtaining module, a mask determination module, a filtering module, a first restoration module and a second restoration module; wherein
the second obtaining module is configured to obtain a target detection result with a defective-spot output by a defective-spot detection model, a first video frame corresponding to the target detection result with the defective-spot, and at least one second video frame adjacent to the first video frame in a video stream;
the mask determination module is configured to determine a defective-spot mask of the first video frame based on the target detection result;
the filtering module is configured to perform a filtering process on the first video frame and the at least one second video frame to obtain a first filtered image;
the first restoration module is configured to obtain an initial restored image based on the first filtered image, the defective-spot mask and the first video frame; and
the second restoration module is configured to process, through a defective-spot restoration network model, the first video frame, the at least one second video frame, the defective-spot mask and the initial restored image, so as to obtain a target image with the defective-spot restored.

17. A computer device, comprising:
a processor,
a memory, and
a bus, wherein
the memory stores machine-readable instructions executable by the processor, the processor communicates with the memory over the bus when the computer device runs,
the machine-readable instructions when executed by the processor perform the method of claim 1.

18. A computer non-transitory readable storage medium having a computer program stored thereon, when executed by a processor, performs the method of claim 1.

19. A computer non-transitory readable storage medium having a computer program stored thereon, when executed by a processor, performs the method of claim 10.

20. A computer non-transitory readable storage medium having a computer program stored thereon, when executed by a processor, performs the method of claim 11.
